(19) United States
(12) Patent Application Publication
(10) Pub. No.: US 2003/0010582 A1
(43) Pub. Date: Jan. 16, 2003

(54) Disk brake with integrated brake lining

(75) Inventors: Peter G. Denton, Wipperfurth (DE); Wilfried Strauss, Wald-Michelback (DE)

Correspondence Address: Reising, Ethington, Barnes, Kisselle, Learman & McCulloch P.C., 5291 Colony Drive North, Saginaw, MI, 48603, US

(73) Assignee: Federal-Mogul Friction Products GmbH

(21) Appl. No.: 10/185,291

(22) Filed: Jun. 27, 2002

(30) Foreign Application Priority Data
Jul. 11, 2001 (DE) 101 33 579.2

(51) Int. Cl. F16D 65/40

(52) U.S. Cl. 188/73.38

(57) ABSTRACT

A disk brake including a brake disk, a brake caliper and brake linings (2). The brake caliper comprises a lining shaft (18) in which the brake linings (2) and, if appropriate, at least one pressure distributor plate are held down by means of springs (10). Each of the hold-down springs (10) supports themselves on parts of the brake caliper (20) and of the brake lining (2) and, as appropriate, on parts of the at least one pressure distributor plate. Each of the brake linings (2) comprise a supporting plate (6) and at least one friction lining (4) which, in the disk brake according to the invention, is made from the same material. The brake linings (2) further comprise receiving elements (12) for hold-down springs (10) and at least accessory element (16). The brake caliper comprises receiving elements or line elements for the at least one accessory element.

### FIELD OF THE INVENTION

The present invention relates to an integrated brake lining, a brake caliper with an integrated brake lining, and a disk brake including these components. Specifically, the present invention relates to brake linings comprising a supporting plate and a friction lining and receiving elements for a hold-down spring.

Usually, disk brakes are composed of a brake disk and a brake caliper with a plurality of brake linings. Disk brakes are used in motor vehicles and in machines to brake shafts or wheels. The brake linings used in the brake caliper generally consist of a supporting element and a friction lining. The main advantages of disk brakes over drum brakes which are sometimes still in use today are lower weight, improved heat dissipation and easier maintenance.

Such brake linings are, for example, described in the patent specification laid open to public inspection DE 197 05 836 A1. DE 197 05 836 A1 describes a brake lining whose support comprises a sandwich structure to save weight and to improve the mechanical properties of the brake lining.

At high loads, brake linings are often loaded by so-called pressure distributor plates more uniformly in order to avoid a more non-uniform abrasion of the brake linings. In addition, pressure distributor plates allow the use of thinner and hence more lightweight brake linings. The use of pressure distributor plates and so-called hold-down springs is explained, for example, in EP 0 248 385 B1. EP 0 248 385 B1 illustrates in particular the use and necessity of hold-down springs. The hold-down devices serve to fix the brake linings in the brake anchor plate. To reduce the weight of the brake linings and to simplify the manufacturing method, the brake lining and the supporting plate may be made of one material. This is particularly clearly described in publication EP 0 745 781 A2. In that publication, brake linings are described whose supporting plate and friction lining are composed of the same material. This results in the main advantage that the entire brake lining can be manufactured in one operation.

### OBJECT OF THE INVENTION

It is an object of the present invention to provide a brake lining, a brake caliper and a disk brake which can be manufactured easily, at low cost and in only a few operations and which comprise receiving devices or supplying elements for hold-down springs and accessories to meet the increased safety and comfort requirements of a brake assembly.

### SUMMARY OF THE INVENTION

According to one aspect of the present invention, the invention provides a brake lining for disk brakes. In the brake lining according to the invention, the supporting plate and the friction lining are made from the same material. The brake lining further comprises receiving elements for hold-down springs. The friction lining—of which the supporting plate and the mounting elements for the bold-down springs are made—is made of the same material. The supporting plate and the receiving elements are integrally formed in one piece. This simplifies manufacture enormously.

Preferably, the brake lining further comprises at least one receiving element for accessories. The accessories may be a wear indicator or a wear sensor. Alternatively, the accessories may be a temperature sensor, a cooling device or an insulating device. The accessories may be integrated into the brake lining even during manufacture. Alternatively, the accessories may be an acceleration sensor which, for example, can provide information on the instantaneous condition of the road, the unbalance in the wheel, possible damage to the disk brake, wheel bearings, wheel suspension or tire and/or tire pressure. A suitable acceleration sensor with an appropriate signal processing. e.g. with Fourier analysis, is able to detect damage in time before an extensive damage or a breakdown occurs.

Preferably, the friction lining, supporting plate and receiving elements are integrally made from one material. This ensures an inexpensive production of the brake lining. The material may comprise the mechanical properties of the friction lining. The material of the supporting plate and friction lining may, however, be characterized by a different micro- or macrostructure or by a different density. Of course, this also applies to the receiving elements and accessories. The strength values required for the receiving elements may be varied, e.g. the receiving elements may be designed to be thicker. Another way to change the mechanical properties of the receiving elements is to particularly compress or cross-link the material, e.g. a thermosetting plastic, through partial process design.

Preferably, the friction lining and the supporting plate are composed from separate components. preferably, the receiving elements for accessories will be made of another material than the friction linings. By this, e.g. a reinforcing ply in the brake lining which extends in the area of the receiving elements may be meant. Alternatively, the receiving elements may be incorporated into the brake lining as a separate component during manufacture. The accessories may also be incorporated directly into the brake lining. For example, a leaf or coil spring (e.g. in a guiding means), a temperature sensor and/or a wear sensor may be incorporated directly into the brake lining during manufacture.

The brake lining or the friction lining and the supporting plate may be made of all friction lining materials known to those skilled in the art. Typically, friction linings are made of sintered materials or thermosetting plastics in a material compound. Usually, sintered materials consist of mixtures of ferrous and non-ferrous metals. Thermosetting plastics may be made from phenolic resins, epoxy resins, etc. Thermosetting plastics are reinforced with fibres and other filling materials to optimize the material properties. The fibres may be natural, mineral, polymer, metal, aramide and/or carbon fibres, for example. The fibres may be processed in a fibrous condition, as chips, as-spun, as-inweaved, as-knitted and/or e.g. as a fleece. Metallic filling materials may be, for example, ferrous or non-ferrous metals such as Fe, Sn, Zn, Ni, Ag, Al, Mg and/or Mn. Non-ferrous filling materials may be, for example, mineral substances such as calcium hydroxide, heavy spar, rubber and/or vermiculite.

Preferably, the brake lining further comprises a heat insulator. This heat insulator may be directly contained in the brake lining or may be located in or on the brake lining as an independent layer. The particular shape of the heat insulator is of no importance. The heat insulator may be formed by incorporated air pockets, particular structures such as spongy structures or other materials.

The object of the present invention is further accomplished by a brake caliper for a disk brake. In the brake caliper according to the invention, hold-down springs prevent the brake linings from strongly moving within the lining shafts for receiving the brake linings and hence from damaging the lining shafts. Each brake lining comprises a supporting plate, at least one friction lining and receiving elements for the hold-down spring all of which are made from the same material. The receiving elements and the supporting plate are integrally connected to each other.

Preferably, the brake caliper and/or brake lining further comprise mounting elements for accessories. The brake linings and/or brake tongs comprise receiving devices for accessories. Both the supporting plate and the friction lining are made from the same material. The brake linings may be made in one piece. The receiving devices for the accessories and the hold-down springs in the brake linings are either made from the same material or another suitable material. The brake calipers require additional receiving or supplying devices for the supply of the accessories of the brake linings or for additional accessories.

The accessories may be a wear indicator of the brake lining or a temperature sensor in the brake lining which issues a danger signal at overheating of or additional damage to the brake lining. Further accessories may be, for example, a fluid cooler for the brake caliper which can prevent vapour lock in the brake system or damage to the brake caliper or brake fluid. In addition, the brake caliper may comprise supply lines for the wear sensor, temperature sensor, etc.

The object is accomplished according to another aspect of the invention by providing a disk brake comprising a brake disk, a brake caliper and brake linings. The brake caliper comprises a lining shaft in which the brake linings are held down by means of springs. The springs support themselves on the brake caliper and in receiving elements for the springs which are formed on the brake lining. Each brake lining comprises a supporting plate and at least one friction lining. The friction lining, supporting plate and receiving elements are all made from the same material and the receiving elements and the supporting plate are integrally connected to each other.

Preferably, the disk brake including the brake caliper and/or brake lining comprises additional mounting elements for accessories. The disk brake may comprise additional accessories in or on the brake disk, such as wear indicators or temperature sensors for the brake disk. In addition, a special feature of the brake lining may be that receiving devices for accessories are incorporated into the brake lining. The accessories may also be incorporated into the brake lining during manufacture or may be firmly connected to the brake lining. The brake caliper and, if required, the brake disk may be provided with receiving or supplying elements to receive or supply the or additional accessories. In the most simple case, the accessories are another hold-down spring needed to prevent the disk brake from damage when used in a wheel suspension. Alternatively, the accessories may be a wear sensor incorporated into the brake lining or fixed to the brake lining which indicates that the brake lining must be replaced. In vehicles, the advantage over conventional wear indicators is that wear is sensible without needing to detach the wheel. As the wear sensor, depending on the design, must be supplied or requires at least an electric line to pass on a signal, the brake caliper must also be provided at least with a cable or another supply line.

Additional accessories which may be fixed to the brake caliper may be anti-lock braking system sensors, a compressed-air cooler for the brake disk, a telemetry device for the tire pressure or a tire wear sensor, etc. As brake calipers are components manufactured with a very high technical precision which are usually made by means of lost-wax casting, the fastening elements for accessories are easy to integrate during manufacture.

### BRIEF DESCRIPTION OF DRAWING

FIG. 1 shows a cross section of the disk brake according to the invention.

### DETAILED DESCRIPTION OF DRAWING

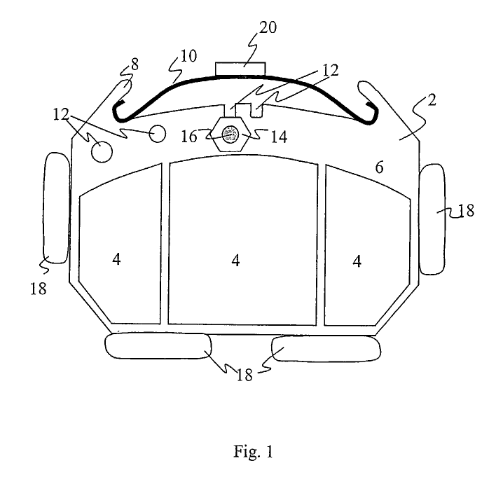

FIG. 1 shows a brake lining according to the invention. The brake lining 2 comprises a supporting plate 6 and friction linings 4 each of which are made from the same material. The supporting plate 6 comprises at one end receiving elements 8 for a hold-down spring 10. The hold-down spring 10 is shown as a leaf spring. The hold-down spring 10 serves to prevent the brake lining 2 from striking against the guides 18, 20 of the lining shaft of a brake caliper and damaging them when the chassis moves. The leaf spring 20 shown in the drawing may be supplemented with coil spring elements, for example. The supporting plate 6 further comprises receiving elements 12 for accessories. A wear sensor 16 is screwed into a receiving element 12 by means of a nut 14. Alternatively, the wear sensor 16 may be arranged in the friction lining 4 or between the friction lining 4 and the supporting plate 6. Preferably, the accessories are integrated into the brake lining 2 during the manufacture of the supporting plate 6 and friction lining 4. In addition, the structure of the brake lining 2, in which both the supporting plate 6 and the friction lining 4 are made from the same material, has the advantage that, even if the friction lining 4 is completely used up, the supporting plate 6 does not damage the brake disk, because it is made from the same material.

The disk brake, the brake caliper and the brake linings may be driven hydraulically, pneumatically, electrically, magnetically, electromechanically or even mechanically. It is to be noted that the disk brake according to the invention is suited for both external-caliper and internal-caliper disk brakes. In external-caliper disk brakes, the brake caliper reaches from the outside across the brake disk in the known manner. In internal-caliper disk brakes, the brake caliper reaches across the brake disk from the inside. The brake linings according to the invention may be used in both fixed-caliper and floating-caliper brake disks. The brake linings according to the invention are suited for both single-piston and multipiston brake calipers. The invention is not restricted to the use with a particular brake disk. The brake lining according to the invention may be used in combination with single, open-worked, grooved, structured, curved and/or internally ventilated brake disks. The brake disk may be mounted in a fixed or floating manner. Even the use in a multidisk brake is possible. In motor lorries, for example, the above fluid coolers may be designed as a compressed-air cooler in which, for example, the pneumatic system of the brake assembly fills a secured reservoir which cools the brake or parts of the brake with compressed air as required. In vehicles without a pneumatic brake system, the brakes may be connected to the existing or a separate refrigeration cycle, e.g. for oil or cooling water.

The disk brake, the brake caliper and the brake lining may be used in any technical field in which rotations are to be slowed down, namely in all automotive applications, in land crafts, rail vehicles, watercrafts, aircrafts, in which shafts and wheels need to be braked. Other applications are brakes for machines, motors, rotors, windmills, roundabouts, etc.

1. A brake lining for disk brakes comprising a supporting plate, at least one friction lining and receiving elements for a hold-down spring, wherein the supporting plate, the friction lining and the receiving elements for a hold-down spring are made from the same material, wherein the receiving elements and the supporting plate are integrally formed.

2. The brake lining according to claim 1, wherein the brake lining further comprises at least one receiving element for accessories.

3. The brake lining of claim 1, wherein the friction lining, the supporting plate and the receiving elements are integrally made from one material.

4. The brake lining of claim 1, wherein the friction lining and the supporting plate are composed of separate components.

5. The brake lining of claim 1, wherein the brake lining further comprises a heat insulator to minimize the heat transmission from the brake lining to the adjacent brake caliper.

6. A brake caliper for a disk brake which comprises brake linings and a lining shaft in which the brake linings are held down by springs, wherein each of the springs supports itself on the brake caliper and in receiving elements for the springs which are formed on the brake lining, wherein each of the brake linings comprises one supporting plate and at least one friction lining, wherein the supporting plate, the friction lining and the receiving elements are all made from the same material and that the receiving elements and the supporting plate are integrally connected to each other.

7. The brake calliper according to claim 6, wherein the brake caliper and the brake lining further comprise mounting elements for accessories.

8. A disk brake comprising a brake disk, a brake caliper and brake linings, wherein the brake caliper comprises a lining shaft in which the brake linings are held down by springs, wherein the springs support themselves on the brake caliper and in the receiving elements for the springs which are formed on the brake lining, each of the brake linings comprising a supporting plate and at least one friction lining, wherein the supporting plate, the friction lining and the receiving elements are all made from the same material and wherein the receiving elements and the supporting plate are integrally connected to each other.

9. The disk brake according to claim 8, wherein the brake caliper and the brake lining further comprise mounting elements for accessories.
